(19) United States
(12) Patent Application Publication
(10) Pub. No.: US 2017/0199832 A1
(43) Pub. Date: Jul. 13, 2017

(54) SIGNALING PROTOCOLS FOR RADIO FREQUENCY FRONT-END CONTROL INTERFACE (RFFE) BUSES

(71) Applicant: QUALCOMM Incorporated, San Diego, CA (US)

(72) Inventors: Lalan Jee Mishra, San Diego, CA (US); Richard Dominic Wietfeldt, San Diego, CA (US)

(21) Appl. No.: 14/994,242

(22) Filed: Jan. 13, 2016

(51) Int. Cl. G06F 13/364; G06F 13/40; G06F 13/42

(52) U.S. Cl. CPC G06F 13/364; G06F 13/4282; G06F 13/404

(57) ABSTRACT

Signaling protocols for radio frequency front-end control interface (RFFE) buses are disclosed. In an exemplary aspect, the RFFE protocol is modified to provide addresses that are shorter than the normal four bits allocated by the RFFE protocol. By allocating fewer bits to an address, frames sent across an RFFE bus are shorter, and thus, bus turnaround time is improved, which reduces overall latency. Further, it is possible that shorter messages may provide incremental power savings. In a further exemplary aspect, different portions of a frame are transmitted using different data rates. In particular, a bus management portion may be sent using a single data rate (SDR), and a payload portion may be sent using a double data rate (DDR). The net effect of using the DDR on the payload portion is to reduce bus turnaround time, and thus, reduce latency.

### BACKGROUND

I. Field of the Disclosure

The technology of the disclosure relates generally to a signaling protocol for use on a communication bus and particularly for a radio frequency front-end control interface (RFFE) bus.

II. Background

Computing devices have become increasingly common in modern society. Amongst the more common computing devices are mobile phones. While such devices may initially have started out as simple devices that allowed audio communication through the Public Land Mobile Network (PLMN) to the Public Standard Telephone Network (PSTN), they have evolved into smart phones capable of supporting full multimedia experiences as well as supporting multiple wireless protocols. Even within the cellular wireless protocols, mobile phone radios have developed into highly complex, multi-band, and multi-standard designs that often have multiple radio frequency (RF) signal chains. Every component in an RF signal chain has to be in a desired configuration at any given time, or the system will fail. Therefore, accurate timing, triggers, and speed are all necessary.

As further explained in the MIPI Alliance website, “[t]he MIPI Alliance Specification for RF Front-End Control Interface (RFFE) was developed to offer a common and widespread method for controlling RF front-end devices. There are a variety of front-end devices, including Power Amplifiers (PA), Low-Noise Amplifiers (LNA), filters, switches, power management modules, antenna tuners and sensors. These functions may be located either in separate devices or integrated into a single device, depending on the application. The trend in mobile radio communications is towards complex multi-radio systems comprised of several parallel transceivers. This implies a leap in complexity of the RF front-end design. Thus, the RFFE bus must be able to operate efficiently in configurations from the simplest one Master and one Slave configuration to, potentially, multi-Master configurations with tens of Slaves.”

Current incarnations of the RFFE protocol, and particularly the control signaling protocols, require multiple microseconds to achieve a state change. Sub-microsecond state changes are possible by increasing a bus clock frequency. However, increasing the bus clock frequency has a direct penalty on power and adds to chip-level and board-level design constraints as the faster bus clock frequency makes electromagnetic compatibility (EMC) more problematic. Delays in the state change results in excessive bus hold-up time, which in turn may lead to latency in operation of RFFE elements. Thus, there needs to be a way to improve bus turnaround without increasing the bus clock frequency.

### SUMMARY OF THE DISCLOSURE

Aspects disclosed in the detailed description include signaling protocols for radio frequency front-end control interface (RFFE) buses. In an exemplary aspect, the RFFE protocol is modified to provide addresses that are shorter than the normal four bits allocated by the RFFE protocol. By allocating fewer bits to an address, frames sent across an RFFE bus are shorter, and thus, bus turnaround time is improved, which reduces overall latency. Further, it is possible that shorter messages may provide incremental power savings. In a further exemplary aspect, different portions of a frame are transmitted using different data rates. In particular, a bus management portion may be sent using a single data rate (SDR), and a payload portion may be sent using a double data rate (DDR). The net effect of using the DDR on the payload portion is to reduce bus turnaround time, and thus, reduce latency.

In this regard in one aspect, a method of constructing an address field for a frame on an RFFE bus is disclosed. The method includes ascertaining a total number of addresses for devices associated with an RFFE bus. The method also includes calculating a number of bits required to provide the total number of addresses. The method also includes setting a bit-field address-field length for a frame at a minimum number of bits based on the calculating.

In another aspect, a method of transmitting a frame on an RFFE bus is disclosed. The method includes transmitting a first portion of a frame over an RFFE bus using an SDR technique. The method also includes transmitting a second portion of the frame over the RFFE bus using a DDR technique.

In another aspect, a master is disclosed. The master includes an interface. The interface is configured to couple to an RFFE bus. The master also includes a transmitter. The transmitter is configured to transmit over the RFFE bus through the interface. The master also includes a control system communicatively coupled to the transmitter. The control system is configured to ascertain a total number of addresses for devices associated with the RFFE bus. The control system is also configured to calculate a number of bits required to provide the total number of addresses. The control system is also configured to set a bit-field address-field length for a frame at a minimum number of bits based on the calculating.

In another aspect, a device is disclosed. The device includes an interface configured to couple to an RFFE bus. The device also includes a transmitter configured to transmit over the RFFE bus through the interface. The device also includes a receiver configured to receive data over the RFFE bus through the interface. The receiver includes a decoder configured to decode both SDR data and DDR data.

### BRIEF DESCRIPTION OF THE FIGURES

FIG. 1 is a block diagram of an exemplary computing device incorporating a radio frequency front-end control interface (RFFE) bus;

FIG. 2 a simplified block diagram of an RFFE system coupled to the RFFE bus;

FIG. 3 is a flowchart illustrating an exemplary process of determining and using a shorter address for devices on the RFFE bus in the RFFE system;

FIG. 4 is a bit-level diagram of a bus management portion of an RFFE control frame according to an exemplary aspect of the present disclosure;

FIG. 5 is a bit-level diagram of various frame structures according to exemplary aspects of the present disclosure;

FIG. 6 is a flowchart illustrating an exemplary process of determining and using a shorter address for registers on the RFFE bus in the RFFE system; and

FIG. 7 is a flowchart illustrating an exemplary process for using a heterogeneous data rate for frames sent across the RFFE bus.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include signaling protocols for radio frequency front-end control interface (RFFE) buses. In an exemplary aspect, the RFFE protocol is modified to provide addresses that are shorter than the normal four bits allocated by the RFFE protocol. By allocating fewer bits to an address, frames sent across an RFFE bus are shorter, and thus, bus turnaround time is improved, which reduces overall latency. Further, it is possible that shorter messages may provide incremental power savings. In a further exemplary aspect, different portions of a frame are transmitted using different data rates. In particular, a bus management portion may be sent using a single data rate (SDR), and a payload portion may be sent using a double data rate (DDR). The net effect of using the DDR on the payload portion is to reduce bus turnaround time, and thus, reduce latency.

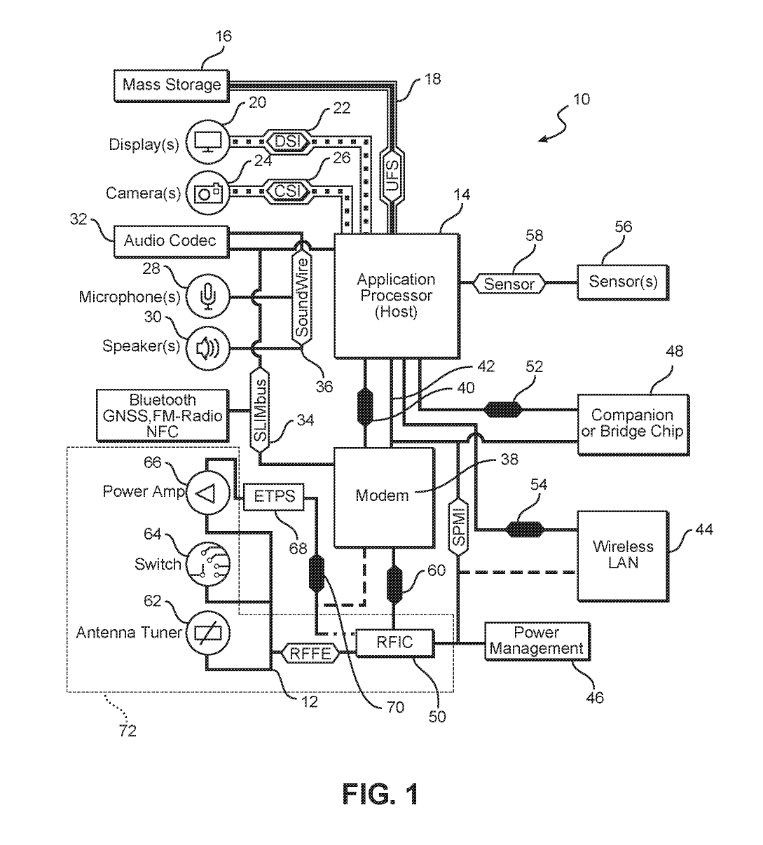

To assist in explanation of exemplary aspects of the present disclosure, an overview of a computing device, such as a mobile terminal, that includes an RFFE bus is provided with reference to FIG. 1. In this regard, FIG. 1 is system-level block diagram of a mobile terminal 10 such as a smart phone, mobile computing device tablet, or the like. While the mobile terminal 10 is particularly contemplated as being capable of benefiting from exemplary aspects of the present disclosure, it should be appreciated that the present disclosure is not so limited and may be useful in any system having a bus that may benefit from faster bus turnaround. For the sake of illustration, it is assumed that an RFFE bus 12 within the mobile terminal 10 and its associated elements operate according to the present disclosure.

With continued reference to FIG. 1, the mobile terminal 10 includes an application processor 14 (sometimes referred to as a host) that communicates with mass storage element 16 through a universal flash storage (UFS) bus 18. The application processor 14 may further be connected to a display 20 through a display serial interface (DSI) bus 22 and a camera 24 through a camera serial interface (CSI) bus 26. Various audio elements such as a microphone 28, a speaker 30, and an audio codec 32 may be coupled to the application processor 14 through a serial low-power interchip multimedia bus (SLIMbus) 34. Additionally, audio elements may communicate with each other through a SOUNDWIRE™ bus 36. A modem 38 may also be coupled to the SLIMbus 34. The modem 38 may further be connected to the application processor 14 through a peripheral component interconnect (PCI) or PCI express (PCIe) bus 40 and/or a system power management interface (SPMI) bus 42.

With continued reference to FIG. 1, the SPMI bus 42 may also be coupled to a wireless local area network (LAN) integrated circuit 44, a power management integrated circuit (PMIC) 46, a companion integrated circuit (sometimes referred to as a bridge chip) 48, and a radio frequency integrated circuit (RFIC) 50. It should be appreciated that separate PCI buses 52 and 54 may also couple the application processor 14 to the companion integrated circuit 48 and the wireless LAN integrated circuit 44. The application processor 14 may further be connected to sensors 56 through a sensor bus 58. The modem 38 and the RFIC 50 may communicate using a bus 60.

With continued reference to FIG. 1, and of particular interest for the present disclosure, the RFIC 50 may couple to one or more RFFE elements, such as an antenna tuner 62, a switch 64, and a power amplifier 66 through the RFFE bus 12. Additionally, the RFIC 50 may couple to an envelope tracking power supply (ETPS) 68 through a bus 70, and the ETPS 68 may communicate with the power amplifier 66. Collectively, the one or more RFFE elements, including the RFIC 50, may be considered an RFFE system 72.

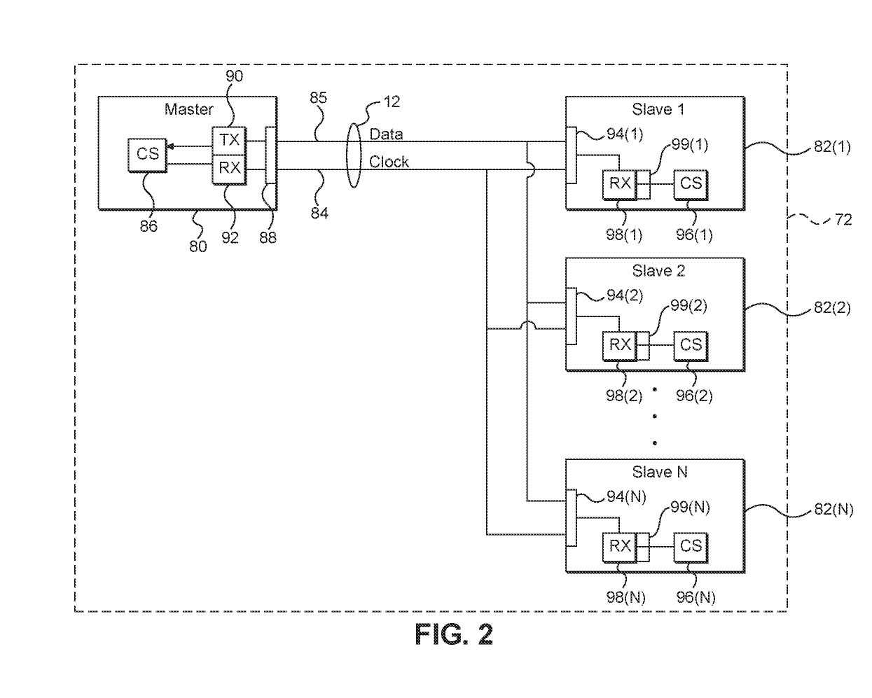

A simplified version of the RFFE system 72 of FIG. 1 is provided with reference to FIG. 2. In particular, the RFFE system 72 may include one or more master(s) 80 (only one illustrated) and slaves 82(1)-82(N) coupled to the RFFE bus 12. The RFFE bus 12 includes a clock line 84 and a data line 85. The master 80 may include a control system (also referred to in the drawings as CS) 86 and a bus interface 88 that couples to the RFFE bus 12. Note that the master 80 further includes a transmitter 90 and a receiver 92 operatively coupled to the control system 86 and the bus interface 88. Similarly, each slave of the slaves 82(1)-82(N) includes a respective bus interface 94(1)-94(N), a respective control system (also referred to in the drawings as CS) 96(1)-96(N), and a respective receiver 98(1)-98(N). Each receiver 98(1)-98(N) may include a respective decoder 99(1)-99(N) that operates to decode SDR and DDR or other High Data Rate (HDR) signals. While the decoding that is performed by the decoders 99(1)-99(N) may be conventional, the presence of the decoders 99(1)-99(N) is a modification to RFFE elements since the RFFE elements currently only use SDR encoding. While illustrated as a single decoder that decodes both SDR and DDR, in reality, the decoders may be separate circuits (i.e., an SDR and a DDR circuit) associated with the receivers 98(1)-98(N). Likewise, the decoders 99(1)-99(N) may be positioned within the receivers 98(1)-98(N) or separate therefrom without departing from the present disclosure. The use of the decoders 99(1)-99(N) is explained in greater detail below. It should be appreciated that while not illustrated, the slaves 82(1)-82(N) may further include a transmitter and other elements as is well understood. It should be appreciated that every device associated with the RFFE bus 12 has a unique address and may have a group address. In the case of a slave, the addresses are a unique slave identification (USID) and group slave identification (GSID), respectively.

In normal operation, control frames on the RFFE bus 12 may include two portions, an address portion and a payload portion. Exemplary aspects of the present disclosure modify one or both portions of the control frames to provide shorter bus turnarounds, which in turn reduces latency and allows cellular protocol timing requirements to be met without having to increase clock speed.

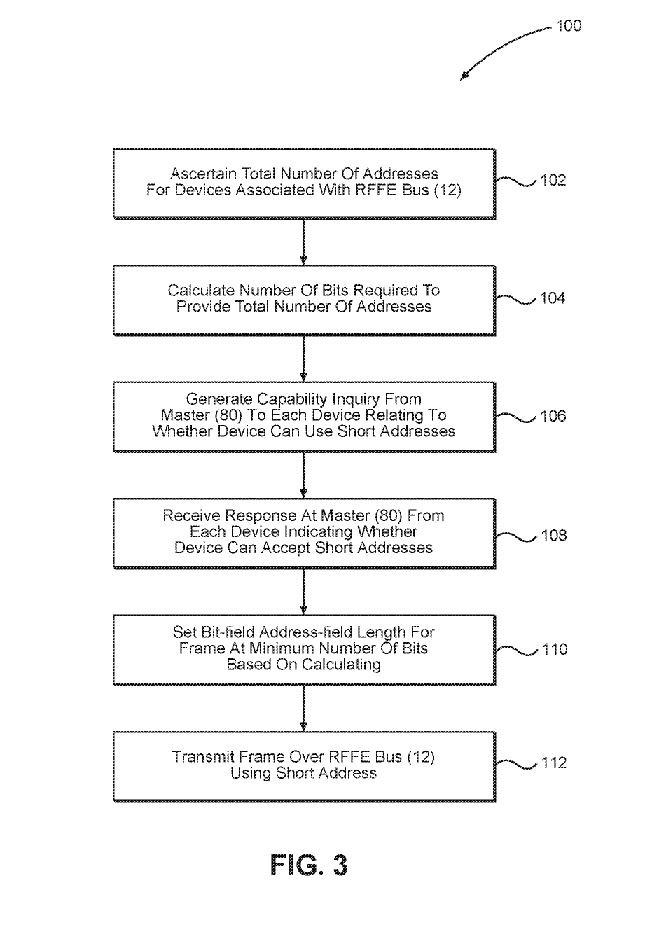

An exemplary process 100 is provided with reference to FIG. 3 illustrating constructing an address field for a frame sent on the RFFE bus 12. The process 100 begins by ascertaining a total number of addresses for devices associated with the RFFE bus 12 (block 102). As noted above, the slaves 82(1)-82(N) may have addresses corresponding to respective USIDs and may have one or more GSIDs. Regardless, there is a maximum number of addresses needed for all the devices associated with the RFFE bus 12. This number may be known a priori by a designer and provided to the control system 86, or the control system 86 may ascertain this maximum number at system start-up during an enumeration process.

With continued reference to FIG. 3, based on the maximum number of addresses, the control system 86 may calculate a number of bits required provide the total number of addresses (block 104). Alternatively, the designer may perform the calculation and provide the number of bits to the control system 86 such as in a look-up table or other memory element. As used herein, “calculate” includes such reference to pre-providing the number of bits.

With continued reference to FIG. 3, the control system 86 of the master 80 may generate a capability inquiry to each device (e.g., the slaves 82(1)-82(N)) relating to whether the device can use short addresses according to exemplary aspects of the present disclosure (block 106), and then the master 80 receives a response from each device indicating whether the device can accept short addresses (block 108). Note that the capability inquiry may be performed on system start-up or reset or may, in some instances be omitted entirely. Omission of the capability inquiry is possible in those instances where the designer knows that all elements on the RFFE bus 12 are capable of using the short addresses. To the extent that most elements on the RFFE bus 12 are static and not likely to change over the life of the mobile terminal 10, it may be safe to assume that if a starting configuration at the design stage implements devices capable of supporting this functionality, then such configuration does not change and the aspects of the present disclosure may be implemented without additional capability inquiries.

With continued reference to FIG. 3, the control system 86 then sets a bit-field address-field length for a frame at a minimum number of bits based on the calculating (block 110). Thus, for example, if only four addresses are needed, then an address-field need only be two bits (i.e., two bits gives addresses of 00, 01, 10, and 11—or four addresses); if eight or fewer addresses are needed, then an address-field need only be three bits.

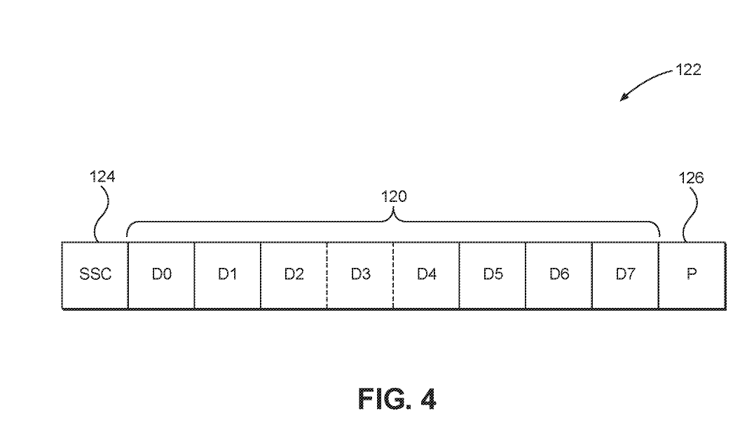

An exemplary bus management portion 120 of a frame 122 is illustrated with reference to FIG. 4. The bus management portion 120 begins after a sequence start condition (SSC) bit 124 and, in the absence of the present disclosure, is eight bits D0-D7 ending with a park (P) bit 126. Bits DO-D3 are address bits used for the USID or the GSID. Note that bits D2 and D3 may be omitted if the address field has been shortened. Instead of a conventional eight-bit GSID of the RFFE protocol, bit D5 indicates whether the address is a USID or a GSID. Further changing the RFFE protocol, bits D6 and D7 collectively indicate whether the frame 122 is a write mode (nibble extension), a read mode (nibble extension), a masked write-read mode (byte extension), or a register mode (hardware extension). Bit D4 indicates whether the frame 122 uses just SDR or if the frame 122 uses a heterogeneous SDR/DDR format as explained in greater detail below.

While the RFFE protocol assumes that there will be four bits for a USID or eight bits for a GSID in the address portion, exemplary aspects of the present disclosure allow fewer than four bits to be used for the device address. By shortening the address portion even by one bit, the amount of time used to communicate the address is shortened, which in turn reduces bus turnaround. Thus, returning to FIG. 3, the process 100 continues by transmitting frames over the RFFE bus 12 using the short addresses (block 112).

The size of the frame 122 may be further shortened through myriad techniques. In one exemplary aspect of the present disclosure, the payload portion of the frame 122 may be limited. Currently, the RFFE protocol allows up to sixteen bytes of data to be sent in the payload portion. The present disclosure proposes limiting the payload portion to three bytes. By limiting the payload portion to three bytes, bus hold-up time is lowered and latency improved. Still further, a register address may be size-limited in a fashion similar to the device address. Elimination of excessively long register addresses also reduces frame size and thus, reduces the bus hold-up time.

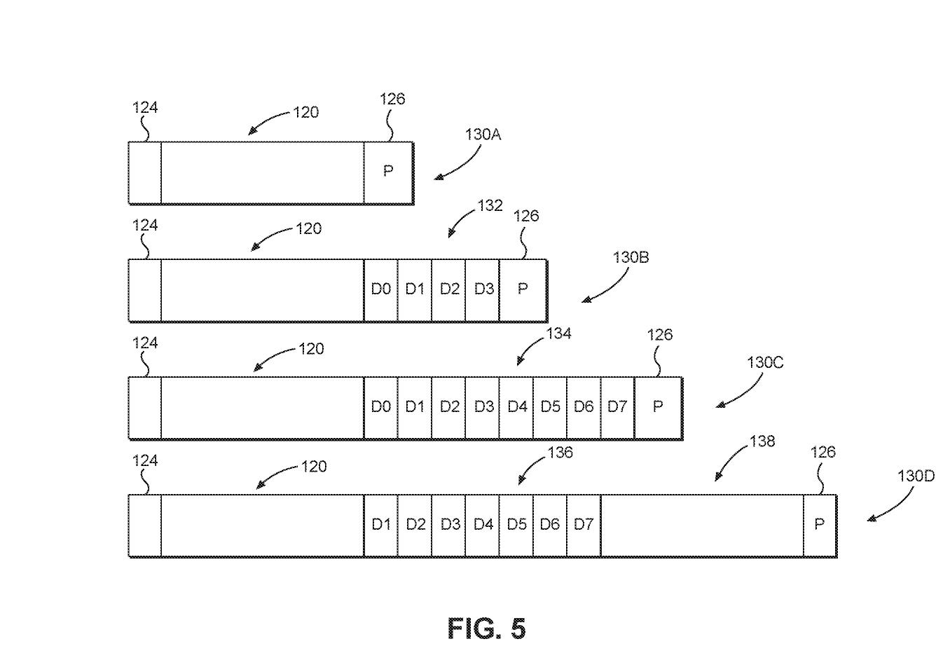

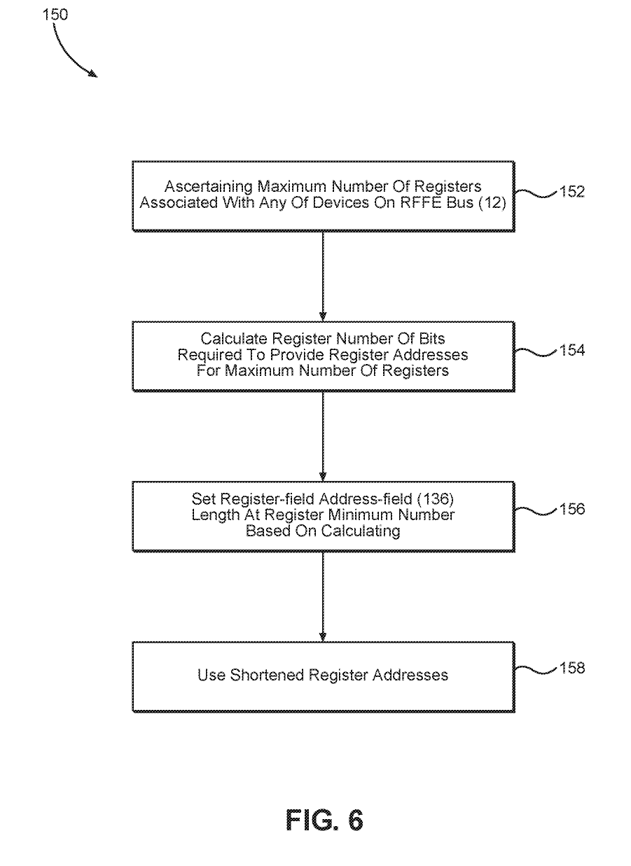

In this regard, FIG. 5 illustrates various frame structures 130A-130D. Frame structure 130A corresponds to the bus management portion 120 of FIG. 4 with the SSC bit 124 and the P bit 126. The frame structure 130A may be used for special communication modes such as broadcast, reset, interrupt-discovery, or the like. These commands may be sent in the bits D6 and D7, with an address of 1-1-1-1 in the four bits DO-D3. The frame structure 130A may sometimes be referred to as a seed byte. Frame structure 130B is a four-bit input/output mode that includes the bus management portion 120 and a payload portion 132 having four bits therein before the P bit 126. The bus management portion 120 of the frame structure 130B may use a USID or a GSID. The frame structure 130B may sometimes be referred to as a nibble extended seed byte. Frame structure 130C is a masked-write mode that includes a one to four bit write command A read before write sequence is not needed, which also helps reduce the bus hold-up. The frame structure 130C has a payload portion 134, which holds up to eight bits, including a one to four bit write command. The other four bits may be mask bits. In an alternate aspect, the number of mask and data bits may be varied to reduce the overall length of the frame structure 130C. Again, the frame structure 130C may use a USID or a GSID in the bus management portion 120. Frame structure 130D is a register mode that includes the bus management portion 120, a register-field address-field portion 136 and a data portion 138. It is the data portion 138 that may be limited to the three bytes as outlined above. Further, the register-field address-field portion 136 may be shortened as outlined in process 150, discussed below with reference to FIG. 6. The frame structure 130D may be referred to as a half-word extended seed byte.

FIG. 6 illustrates a process 150 for shortening the register addresses. Process 150 begins by ascertaining a maximum number of registers associated with any of the devices associated with the RFFE bus 12 (block 152). As with the process 100 of FIG. 3, this ascertainment may be done a priori by the designer and provided to the control system 86 or may be done through an enumeration process. The control system 86 may then calculate a register number of bits required to provide the register addresses for the maximum number of registers (block 154). Again, this may be done through a look-up table or by actual calculation. The control system 86 then sets a register-field address-field portion 136 length at a register minimum number of bits based on the calculating (block 156) and the shortened register addresses are used (block 158).

In addition to reducing the frame size so as to reduce the bus hold-up, the present disclosure also provides a heterogeneous data rate during transmission of the frames so as to reduce the amount of time that is spent transmitting the frames. Specifically, in an exemplary aspect, the bus management portion 120 of the frame is sent using an SDR as is set forth in the RFFE protocol. However, the payload portion of the frame is sent using a DDR. By sending data on both the rising and falling edge of the data, the speed of delivery of the payload portion is effectively doubled. Depending on the size of the payload portion, savings may range from 16.67% to 47.30% as set forth in latency reduction Table 1 below, where SA is the bus management portion 120 (eight bits), CMD is the command (8 bits), and Register Address is, in the RFFE protocol up to sixteen bits, and under exemplary aspects of the present disclosure eight bits, and the data to read/write is up to one hundred twenty-eight bits.

TABLE 1
LATENCY REDUCTION

| | | RFFE clock | Disclosure | % Latency |
|---|---|---|---|---|
| Command | Bit Split | cycles | clock cycles | Reduction |
| Reg-0 Write | SA(8)\|CMD(8) | 12 | 10 | 16.67% |
| Reg | SA(8)\|CMD(8)\| | 20 | 14 | 30% |
| Read/Write | Return(8) | | | |
| Extended | SA(8)\|CMD(8)\| | 92 | 50 | 45.65% |
| Register | Reg- | | | |
| RD//Write | Address(16)\| | | | |
| Long | Data(64) | | | |
| Extended | SA(8)\|CMD(8)\| | 148 | 78 | 47.30% |
| Register | Reg- | | | |
| Rd/Wrt | Address(8)\| | | | |
| | data(128) | | | |

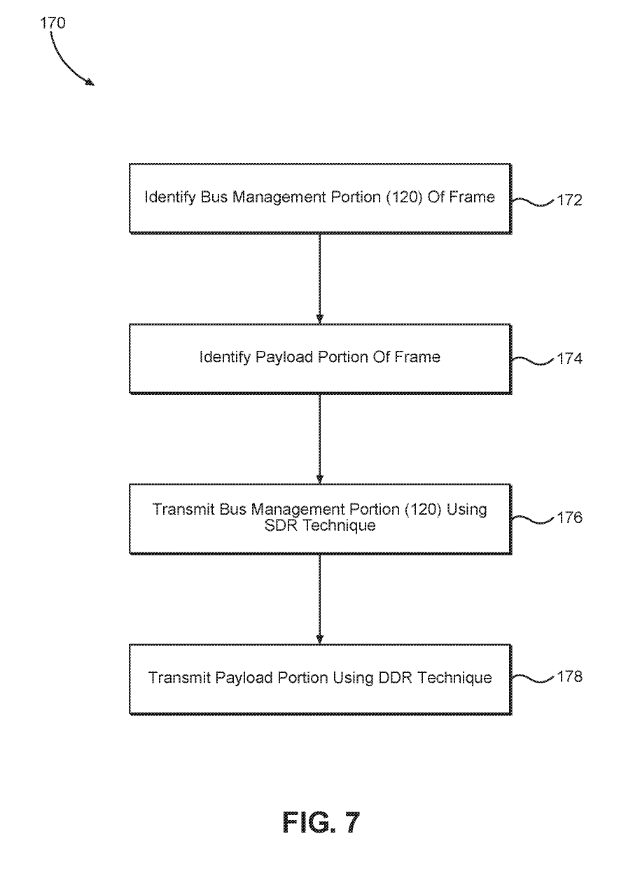

In this regard, FIG. 7 illustrates a process 170 for transmitting the frame on the RFFE bus 12 using the heterogeneous data rate. The process 170 begins by identifying the bus management portion 120 of the frame (block 172) and identifying the payload portion of the frame (block 174). The process 170 continues by transmitting the bus management portion 120 of the frame over the RFFE bus 12 using an SDR technique (block 176). As used herein, the bus management portion 120 of the frame is sometimes referred to as a first portion of the frame. The process 170 continues by transmitting the payload portion of the frame over the RFFE bus 12 using a DDR technique (block 178). As used herein, the payload portion of the frame is sometimes referred to as a second portion of the frame. As noted above, the bus management portion 120 of the frame contains an address that is fewer than four bits. As further noted above, the payload portion of the frame may be limited to fewer than three bytes, which may be inclusive of a shortened register address or in addition to the shortened register address.

The signaling protocols for RFFE buses according to aspects disclosed herein may be provided in or integrated into any processor-based device having a bus that has latency concerns. Examples, without limitation, include a set top box, an entertainment unit, a navigation device, a communications device, a fixed location data unit, a mobile location data unit, a mobile phone, a cellular phone, a smart phone, a tablet, a phablet, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, and an automobile. While all such devices may benefit from the present disclosure, devices relying on a wireless connection and having an RFFE bus will see the greatest benefit from using aspects of the present disclosure

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method of constructing an address field for a frame on a radio frequency front-end control interface (RFFE) bus, the method comprising:
ascertaining a total number of addresses for devices associated with an RFFE bus;
calculating a number of bits required to provide the total number of addresses; and
setting a bit-field address-field length for a frame at a minimum number of bits based on the calculating.

2. The method of claim 1, wherein ascertaining the total number of addresses includes a first number of unique slave identifiers (USIDs) and a second number of group slave identifiers (GSIDs).

3. The method of claim 1, further comprising ascertaining a maximum number of registers associated with any of the devices associated with the RFFE bus;
calculating a register number of bits required to provide register addresses for the maximum number of registers; and
setting a register-field address-field length at a register minimum number of bits based on the calculating.

4. The method of claim 1, further comprising setting a maximum packet payload size for the frame.

5. The method of claim 4, wherein the maximum packet payload size is three bytes.

6. The method of claim 1, further comprising transmitting the frame over the RFFE bus.

7. The method of claim 6, wherein transmitting the frame comprises transmitting a bus management portion of the frame at a first data rate and transmitting a payload portion of the frame at a second data rate.

8. The method of claim 7, wherein the first data rate comprises a single data rate (SDR) and the second data rate comprises a double data rate (DDR).

9. The method of claim 1, further comprising generating a capability inquiry from a master to a device relating to whether the device can accept short addresses.

10. The method of claim 9, further comprising receiving a response from the device at the master indicating whether the device can accept the short addresses.

11. A method of transmitting a frame on a radio frequency front-end control interface (RFFE) bus, the method comprising:
transmitting a first portion of a frame over an RFFE bus using a single data rate (SDR) technique; and
transmitting a second portion of the frame over the RFFE bus using a double data rate (DDR) technique.

12. The method of claim 11, wherein transmitting the first portion of the frame comprises transmitting a bus management portion of the frame.

13. The method of claim 12, wherein transmitting the bus management portion of the frame comprises transmitting an address having fewer than four bits.

14. The method of claim 11, wherein transmitting the second portion of the frame comprises transmitting a payload portion of the frame.

15. The method of claim 14, wherein transmitting the second portion of the frame comprises transmitting no more than three bytes in the second portion of the frame.

16. The method of claim 14, wherein transmitting the second portion of the frame comprises transmitting a register address.

17. The method of claim 16, wherein transmitting the register address comprises transmitting a register address of fewer than eight bits.

18. A master comprising:
an interface configured to couple to a radio frequency front-end control interface (RFFE) bus;
a transmitter configured to transmit over the RFFE bus through the interface; and
a control system communicatively coupled to the transmitter and configured to:
ascertain a total number of addresses for devices associated with the RFFE bus;
calculate a number of bits required to provide the total number of addresses; and
set a bit-field address-field length for a frame at a minimum number of bits based on the calculating.

19. A device comprising:
an interface configured to couple to a radio frequency front-end control interface (RFFE) bus;
a transmitter configured to transmit over the RFFE bus through the interface; and
a receiver configured to receive data over the RFFE bus through the interface, the receiver comprising a decoder configured to decode both single data rate (SDR) data and double data rate (DDR) data.
